(19) United States
(12) Patent Application Publication
(10) Pub. No.: US 2023/0081743 A1
(43) Pub. Date: Mar. 16, 2023

(54) OPTICAL MULTIPLEXING/DEMULTIPLEXING METHOD, OPTICAL MULTIPLEXING/DEMULTIPLEXING CIRCUIT, AND MANUFACTURING METHOD THEREOF

(71) Applicant: NIPPON TELEGRAPH AND TELEPHONE CORPORATION, Tokyo (JP)

(72) Inventors: Takui UEMATSU, Musashino-shi, Tokyo (JP); Hidenobu HIROTA, Musashino-shi, Tokyo (JP); Hiroyuki IIDA, Musashino-shi, Tokyo (JP)

(73) Assignee: NIPPON TELEGRAPH AND TELEPHONE CORPORATION, Tokyo (JP)

(21) Appl. No.: 17/794,776

(22) PCT Filed: Feb. 21, 2020
(86) PCT No.: PCT/JP2020/007250

§ 371 Date: Jul. 22, 2022

(51) Int. Cl. G02B 6/28

(52) U.S. Cl. CPC G02B 6/2821

(57) ABSTRACT

An optical multiplexing and demultiplexing method of the present disclosure includes arranging, face to face, a polished surface of a coated optical fiber whose side surface is polished to a core or a vicinity of the core and a polished surface of a plurality of optical waveguides that are arranged in parallel in a longitudinal plane and that each have different propagation constants and whose side surfaces are polished to cores corresponding one to one therewith or vicinities of the cores; and aligning the polished surface of the coated optical fiber and the polished surface of the plurality of optical waveguides so that desired branching ratio is obtained from one end of the coated optical fiber to the end, distal to the former end, of one optical waveguide of the plurality of optical waveguides by relatively moving the polished surface of the coated optical fiber and the polished surface of the plurality of optical waveguides.

### TECHNICAL FIELD

The present disclosure relates to optical multiplexing and demultiplexing methods, optical multiplexing and demultiplexing circuits, and manufacturing methods for optical multiplexing and demultiplexing circuits.

### BACKGROUND ART

There is a need for an optical multiplexing and demultiplexing circuit that is able to demultiplex light from a coated optical fiber currently in use and to multiplex the light to the coated optical fiber currently in use without cutting the coated optical fiber currently in use.

Meanwhile, a manufacturing method for an optical fiber coupler using a side-polishing method has been studied as one of optical multiplexing and demultiplexing techniques for inputting and outputting light signals to and from a coated optical fiber without cutting the coated optical fiber (see Non Patent Literature (NPL) 1, for example). In this manufacturing method for the optical fiber coupler, a coated optical fiber currently in use (currently used coated fiber) is bent, then a coated optical fiber for branching (optical waveguide for branching) is set to face the bent portion from the side surface, and light is demultiplexed from the currently used coated fiber to the optical waveguide for branching or light is multiplexed from the optical waveguide for branching to the currently used coated fiber.

The procedure of the manufacturing method for the optical fiber coupler is as follows.
(1) With respect to a block including a groove into which a currently used coated fiber is to be fitted while forming an arc shape, a currently used coated fiber is accommodated and fixed in the groove, and then a side surface of the currently used coated fiber is polished in such a manner that a coating and a cladding portion thereof are polished to reach a position separated several μm from the core or polished to reach the core.
(2) The side surface of an optical waveguide for branching buried in a block is polished beforehand in such a manner that a coating and a cladding portion thereof are polished to reach a position separated several μm from the core or polished to reach the core.
(3) The polished surface of the currently used coated fiber whose side surface is polished and the polished surface of the optical waveguide for branching whose side surface is polished beforehand are arranged face to face, and the polished surfaces are fixed at positions so that desired branching ratio is obtained by moving the blocks relative to each other in a polished surface direction.

### CITATION LIST

### Non Patent Literature

NPL 1: Uematsu et al., “Study on optical fiber coupler using side-polishing method”, IEICE Tech. Rep., vol. 119, no. 223, OFT2019-36, pp. 23-26, Oct. 2019

### SUMMARY OF THE INVENTION

### Technical Problem

A currently used coated fiber is defined by specifications, standards, and the like of optical fibers. However, even within the definition, there are variations in propagation constants of optical fibers. Moreover, it is difficult to grasp the propagation constant of the optical fiber of the currently used coated fiber at an in-service time without cutting the currently used coated fiber.

Because an optical multiplexing and demultiplexing circuit adopted in the related art uses evanescent coupling generated when cores approach each other, coated optical fibers having the same standards or coated optical fibers having propagation constants equivalent to each other are normally applied to the currently used coated fiber and the optical waveguide for branching. In a case where the propagation constant differs between the currently used coated fiber and the optical waveguide for branching, because the evanescent coupling becomes weaker in strength as the difference in propagation constant increases, multiplex characteristics, demultiplex characteristics, and the like of the optical multiplexing and demultiplexing circuit are deteriorated.

### Means for Solving the Problem

The present disclosure solves the issues described above, and an object thereof is to provide an optical multiplexing and demultiplexing method, an optical multiplexing and demultiplexing circuit, and a manufacturing method for an optical multiplexing and demultiplexing circuit, which are applicable to currently used coated optical fibers having various propagation constants while minimizing influence on the currently used coated optical fibers.

In order to achieve the object described above, in the present disclosure, a polished surface of a coated optical fiber whose side surface is polished to a core or a vicinity of the core and a polished surface of a plurality of optical waveguides that are arranged in parallel in a longitudinal plane, that each have different propagation constants, and whose side surfaces are polished to cores corresponding one to one therewith or vicinities of the cores, are arranged face to face and the polished surfaces are aligned so that desired branching ratio is obtained.

Specifically, an optical multiplexing and demultiplexing method of the present disclosure includes: arranging, face to face, a polished surface of a coated optical fiber whose side surface is polished to a core or a vicinity of the core and a polished surface of a plurality of optical waveguides that are arranged in parallel in a longitudinal plane and that each have different propagation constants and whose side surfaces are polished to cores corresponding one to one therewith or vicinities of the cores; and aligning the polished surface of the coated optical fiber and the polished surface of the plurality of optical waveguides so that desired branching ratio is obtained from one end of the coated optical fiber to the end, distal to the former end, of one optical waveguide of the plurality of optical waveguides by relatively moving the polished surface of the coated optical fiber and the polished surface of the plurality of optical waveguides.

Specifically, in an optical multiplexing and demultiplexing circuit of the present disclosure is configured such that a polished surface of a coated optical fiber whose side surface is polished to a core or a vicinity of the core and a polished surface of one optical waveguide of a plurality of optical waveguides that are arranged in parallel in a longitudinal plane, that each have different propagation constants, and whose side surfaces are polished to cores corresponding one to one therewith or vicinities of the cores are joined.

Specifically, a manufacturing method for an optical multiplexing and demultiplexing circuit of the present disclosure includes: arranging, face to face, a polished surface of a coated optical fiber whose side surface is polished to a core or a vicinity of the core and a polished surface of a plurality of optical waveguides that are arranged in parallel in a longitudinal plane, that each have different propagation constants, and whose side surfaces are polished to cores corresponding one to one therewith or a vicinities of the cores; and fixing the polished surface of the coated optical fiber and the polished surface of the plurality of optical waveguides so that desired branching ratio is obtained from one end of the coated optical fiber to the end, distal to the former end, of one optical waveguide of the plurality of optical waveguides by relatively moving the polished surface of the coated optical fiber and the polished surface of the plurality of optical waveguides.

### Effects of the Invention

According to the optical multiplexing and demultiplexing method, the optical multiplexing and demultiplexing circuit, or the manufacturing method for the optical multiplexing and demultiplexing circuit, it is an object to provide an optical multiplexing and demultiplexing method and an optical multiplexing and demultiplexing circuit, which are applicable to currently used coated optical fibers having various propagation constants while minimizing influence on communication light propagating in the currently used coated optical fibers.

### BRIEF DESCRIPTION OF DRAWINGS

FIG. 1 illustrates a configuration of an optical multiplexing and demultiplexing circuit.

FIG. 2 depicts characteristics of an optical multiplexing and demultiplexing circuit.

FIG. 3 depicts characteristics of an optical multiplexing and demultiplexing circuit.

FIG. 4 depicts characteristics of an optical multiplexing and demultiplexing circuit.

FIG. 5 illustrates a configuration of an optical multiplexing and demultiplexing circuit.

FIG. 6 illustrates a configuration of an optical multiplexing and demultiplexing circuit.

FIG. 7 illustrates a configuration of an optical multiplexing and demultiplexing circuit.

### DESCRIPTION OF EMBODIMENTS

Hereinafter, embodiments of the present disclosure will be described in detail with reference to the drawings. Note that the present disclosure is not limited to the embodiments described below. These embodiments are just illustrative examples, and the present disclosure can be implemented in forms in which various modifications and improvements are added on the basis of knowledge of those skilled in the art. Note that constituent elements with the same reference signs in the specification and the drawings are assumed to be the same constituent elements.

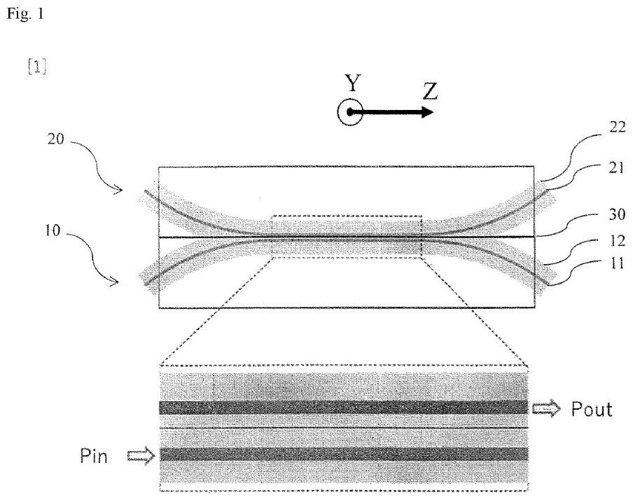

The configuration of an optical multiplexing and demultiplexing circuit of the present disclosure will be described with reference to FIG. 1. In FIG. 1, reference sign 10 denotes a currently used coated optical fiber, reference sign 11 denotes a core of the currently used coated optical fiber, reference sign 12 denotes a cladding region of the currently used coated optical fiber, reference sign 20 denotes a plurality of optical waveguides for branching, reference sign 21 denotes cores of the plurality of optical waveguides for branching, reference sign 22 denotes cladding regions of the plurality of optical waveguides for branching, and reference sign 30 denotes a polished surface. The plurality of optical waveguides for branching 20 may be coated optical fibers or planar optical waveguides. The plurality of optical waveguides for branching 20 are arranged in parallel in a Y direction in FIG. 1, and each have different propagation constants thereof. A side surface of the currently used coated optical fiber 10 and side surfaces of the plurality of optical waveguides for branching 20 are polished to reach the cores corresponding one to one therewith or vicinities of the cores, and the polished surface of the currently used coated optical fiber is joined to the polished surface of one optical waveguide of the plurality of optical waveguides for branching. For the joining, the surfaces may be fixed with an adhesive that also serves as a refractive index matching material, or a refractive index matching material may be applied to mechanically fix the surfaces with a clip. The same applies to the disclosure described below. Desired branching ratio is obtained from one end of the currently used coated optical fiber 10 (Pin direction in FIG. 1) to the end, distal to former end, of one of the optical waveguides for branching 20 (Pout direction in FIG. 1).

An optical multiplexing and demultiplexing method and a manufacturing method for the optical multiplexing and demultiplexing circuit will be described with reference to FIG. 1. In FIG. 1, a polished surface of the coated optical fiber 10 whose side surface is polished to reach the core 11 or a position near the core 11, and a polished surface of the plurality of optical waveguides 20 that are arranged in parallel in a longitudinal plane, that each have different propagation constants, and whose side surfaces are polished to reach the cores or the vicinities of the cores are arranged face to face. Then, the polished surface of the currently used coated optical fiber 10 and the polished surface of the plurality of optical waveguides for branching 20 are moved relative to each other to align the polished surfaces so that desired branching ratio is obtained from the end of the currently used coated optical fiber 10 (Pin direction in FIG. 1) to the distal end of one optical waveguide for branching (Pout direction in FIG. 1) of the plurality of optical waveguides for branching 20. To manufacture the optical multiplexing and demultiplexing circuit, the polished surfaces are further fixed together after the alignment. For the fixing, the surfaces may be fixed with an adhesive that also serves as a refractive index matching material, or a refractive index matching material may be applied to mechanically fix the surfaces with a clip. The plurality of optical waveguides for branching 20 may be coated optical fibers or planar optical waveguides. The same applies to the disclosure described below.

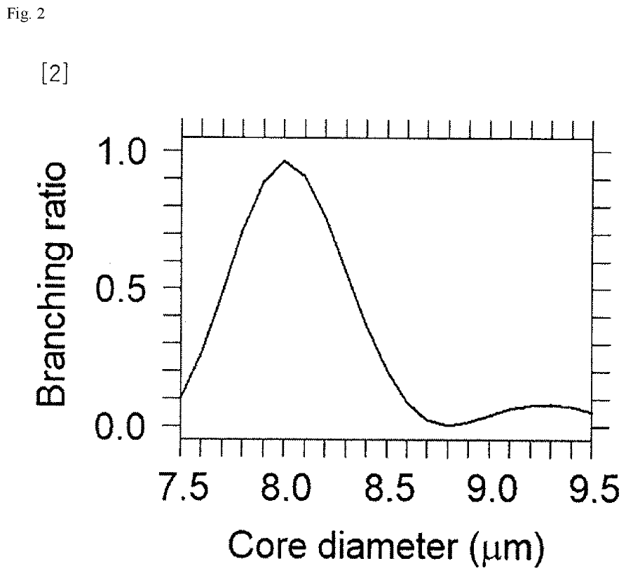

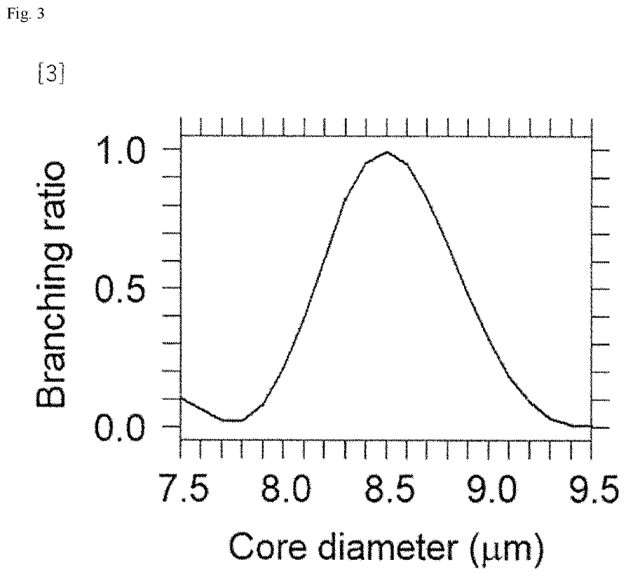

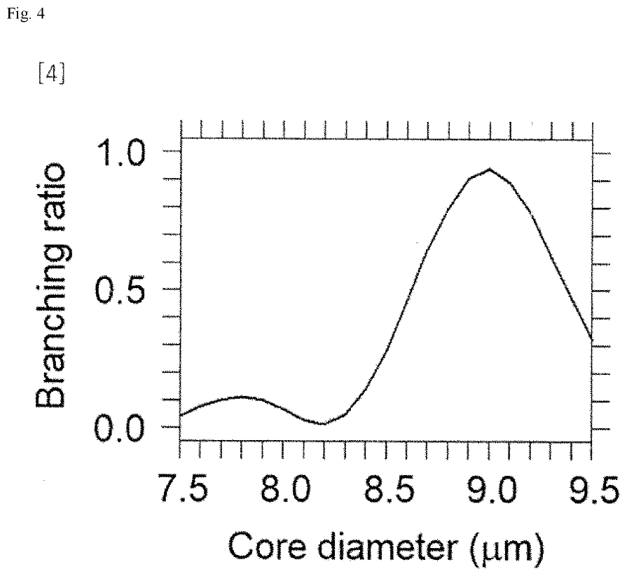

Branching characteristics of the optical multiplexing and demultiplexing circuit depend on a difference between the propagation constant of the currently used coated optical fiber 10 and the propagation constant of each of the plurality of optical waveguides for branching 20. FIGS. 2, 3, and 4 each depict a branching ratio to variation in core diameter of the currently used coated optical fiber 10 under a condition where core diameters of the plurality of optical waveguides for branching 20 are set to be 8, 8.5, and 9 μm. Hereinafter, variability in the propagation constant of the currently used coated optical fiber 10 is exemplified as variability in the core diameter. The branching ratio refers to ratio of Pout/Pin in FIG. 1. In FIGS. 2, 3, and 4, when the core diameter of the currently used coated optical fiber 10 equals the core diameter of the plurality of optical waveguides for branching 20, the value of the branching ratio is 1. However, when the core diameter of the currently used coated optical fiber 10 is not equal to the core diameter of the plurality of optical waveguides for branching, the branching ratio is decreased.

To deal with this, each of the plurality of optical waveguides for branching 20 has a different propagation constant to be managed under a range of an expected propagation constant variability of the currently used coated optical fiber 10. For example, as for an expected propagation constant of the currently used coated optical fiber 10, a position adjustment method will be described taking the core diameter as an example. The core diameters of the plurality of optical waveguides for branching 20 are set to be 8 μm, 8.5 μm, and 9 μm. Even when the core diameter of the currently used coated optical fiber 10 varies in a range from 7.5 to 9 μm, the alignment is carried out so that desired branching ratio is obtained by selecting one optical waveguide of the plurality of optical waveguides for branching 20. When the branching ratio is desired to be increased or to be decreased, by carrying out the alignment so that the desired branching ratio is obtained and fixing the aligned surfaces, the optical multiplexing and demultiplexing circuit as the target is achieved.

According to the optical multiplexing and demultiplexing method, the optical multiplexing and demultiplexing circuit, and the manufacturing method for the optical multiplexing and demultiplexing circuit of the present disclosure, the use of the plurality of optical waveguides for branching that each have different propagation constants makes it possible to multiplex and demultiplex the light with one type or a small number of types of the plurality of optical waveguides for branching for the currently used coated optical fibers having various propagation constants while minimizing influence on the currently used coated optical fibers.

Thus, in accordance with a balance between the variability in propagation constant of the currently used coated optical fiber and the desired value of the branching ratio, one optical waveguide is selected from among the plurality of optical waveguides for branching each having different propagation constants.

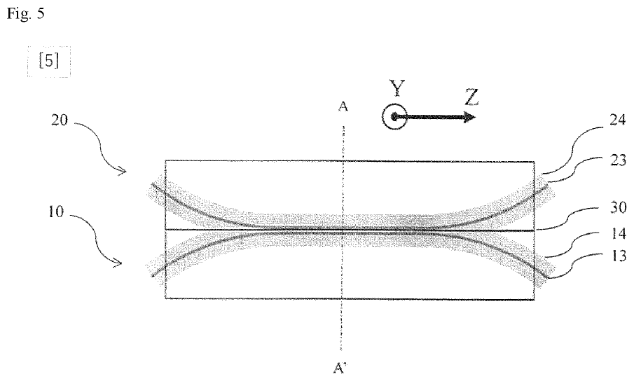

The configuration of an optical multiplexing and demultiplexing circuit of the present disclosure will be described with reference to FIG. 5. In FIG. 5, reference sign 10 denotes a currently used coated optical fiber, reference sign 13 denotes a core of the currently used coated optical fiber, reference sign 14 denotes a cladding region of the currently used coated optical fiber, reference sign 20 denotes a plurality of optical waveguides for branching, reference sign 23 denotes cores of the plurality of optical waveguides for branching, reference sign 24 denotes cladding regions of the plurality of optical waveguides for branching, and reference sign 30 denotes a polished surface. The plurality of optical waveguides for branching 20 may be coated optical fibers or planar optical waveguides. The plurality of optical waveguides for branching 20 are arranged in parallel in a Y direction in FIG. 5.

An optical multiplexing and demultiplexing method and a manufacturing method for the optical multiplexing and demultiplexing circuit will be described with reference to FIG. 5. In FIG. 5, a polished surface of the coated optical fiber 10 whose side surface is polished to reach the core 13 or a position near the core 13, and polished surface of the plurality of optical waveguides for branching 20 that each have different propagation constants and whose side surfaces are each polished to reach the cores 23 corresponding one to one therewith or vicinities of the cores 23, are arranged face to face. Then, the polished surface of the currently used coated optical fiber 10 and the polished surface of the plurality of optical waveguides for branching 20 are moved relative to each other to align the polished surfaces so that the desired branching ratio is obtained from one end of the currently used coated optical fiber 10 to the end, distal to the former end, of the plurality of optical waveguides for branching 20. To manufacture the optical multiplexing and demultiplexing circuit, the polished surfaces are further fixed together after the alignment. For the fixing, the surfaces may be fixed with an adhesive that also serves as a refractive index matching material, or a refractive index matching material may be applied to mechanically fix the surfaces with a clip.

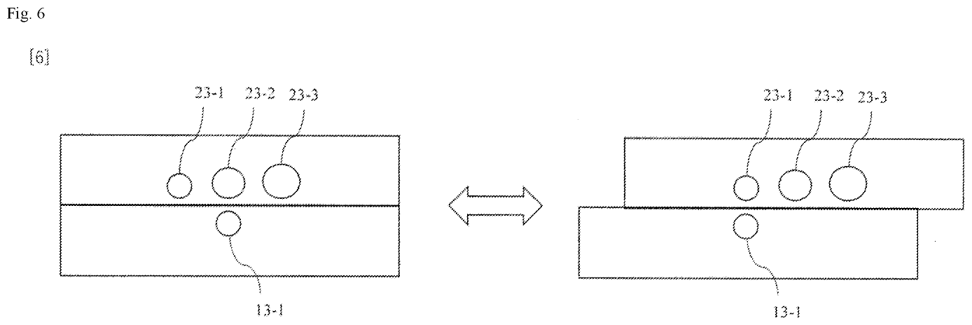

FIG. 6 illustrates a cut plane taken along a line A-A′ in FIG. 5. In FIG. 6, reference sign 13-1 denotes a core of the currently used coated optical fiber, and reference signs 23-1, 23-2, and 23-3 denote cores of the plurality of optical waveguides for branching. The cores of the plurality of optical waveguides for branching each have different core diameters in order to achieve different propagation constants from each other. The polished surface of the currently used coated optical fiber and the polished surface of the plurality of optical waveguides for branching are moved relative to each other in the Y direction illustrated in FIG. 5. That is, the relative movements refer to movements as illustrated on the left side and right side of FIG. 6. The polished surfaces are aligned so that the desired branching ratio is obtained from one end of the currently used coated optical fiber 10 to the end, distal to the former end, of the core (23-1, 23-2, or 23-3) of the optical waveguide whose core diameter is proper of the plurality of optical waveguides for branching 20.

Thus, in accordance with a balance between the variability in propagation constant of the currently used coated optical fiber and the desired value of the branching ratio, one optical waveguide is selected from among the plurality of optical waveguides for branching each having different core diameters.

According to the optical multiplexing and demultiplexing method, the optical multiplexing and demultiplexing circuit, and the manufacturing method for the optical multiplexing and demultiplexing circuit of the present disclosure, the use of the plurality of optical waveguides for branching that each have different core diameters makes it possible to multiplex and demultiplex the light with one type or a small number of types of the plurality of optical waveguides for branching for the currently used coated optical fibers having various propagation constants while minimizing influence on the currently used coated optical fibers.

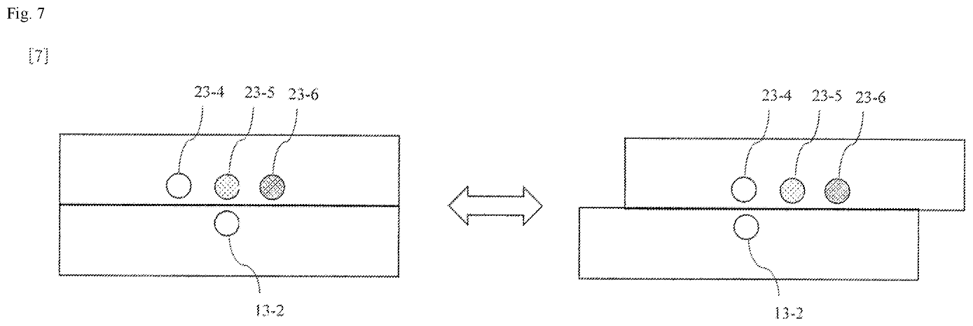

FIG. 7 illustrates a cut plane taken along the line A-A′ in FIG. 5. In FIG. 7, reference sign 13-2 denotes a core of the currently used coated optical fiber, and reference signs 23-4, 23-5, and 23-6 denote cores of the plurality of optical waveguides for branching. The cores of the plurality of optical waveguides for branching each have different refractive indices in order to achieve different propagation constants from each other. The polished surface of the currently used coated optical fiber and the polished surface of the plurality of optical waveguides for branching are moved relative to each other in the Y direction illustrated in FIG. 5. That is, the relative movements refer to movements as illustrated on the left side and right side of FIG. 7. The polished surfaces are aligned so that the desired branching ratio is obtained from one end of the currently used coated optical fiber 10 to the end, distal to the former end, of the core (23-4, 23-5, or 23-6) of the optical waveguide whose core diameter is proper of the plurality of optical waveguides for branching 20.

Thus, in accordance with a balance between the variability in propagation constant of the currently used coated optical fiber and the desired value of the branching ratio, one optical waveguide is selected from among the plurality of optical waveguides for branching each having different refractive indices of cores.

In the present disclosure, only the refractive indices of the cores of the plurality of optical waveguides for branching differ, but only the refractive indices of the cladding regions of the plurality of optical waveguides for branching may differ, or both the refractive indices of the cores of the plurality of optical waveguides for branching and the refractive indices of the cladding regions of the plurality of optical waveguides for branching may differ.

According to the optical multiplexing and demultiplexing method, the optical multiplexing and demultiplexing circuit, and the manufacturing method for the optical multiplexing and demultiplexing circuit of the present disclosure, the use of the plurality of optical waveguides for branching in which at least one of the cores or the cladding regions differ minimizes influence on the currently used coated optical fibers and makes it possible to multiplex and demultiplex the light with one type or a small number of types of plurality of optical waveguides for branching for the currently used coated optical fibers having various propagation constants.

In the present disclosure, the cross sections of each of the plurality of optical waveguides for branching are circular, but a shape other than a circular shape, for example, a rectangular shape may bring the same effect.

In the disclosure described thus far, a case has been exemplified in which the variation in the propagation constant is caused by the variation in the core diameter or the refractive index of the currently used coated optical fiber, but the plurality of optical waveguides for branching of the present disclosure are applicable in a case where the variation in the propagation constant occurs regardless of the variation in the core diameter or the refractive index. Further, an example in which the core diameters of the plurality of optical waveguides for branching differ and an example in which the refractive indices of at least one of the cores or the cladding regions thereon differ have been given, but both of them may differ. Furthermore, a similar effect may be obtained as a plurality of optical waveguides for branching in which the propagation constants are different from each other depending on other parameters than those described above.

### INDUSTRIAL APPLICABILITY

The present disclosure can be applied in the information communication industry.

### REFERENCE SIGNS LIST

10: Currently used coated optical fiber

11, 13, 13-1, 13-2: Core of currently used coated optical fiber

12, 14: Cladding region of currently used coated optical fiber

20: Plurality of optical waveguides for branching

21, 23, 23-1 to 23-6: Core of plurality of optical waveguides for branching

22, 24: Cladding region of a plurality of optical waveguides for branching

30: Polished surface

1. An optical multiplexing and demultiplexing method, comprising:
arranging, face to face, a polished surface of a coated optical fiber whose side surface is polished to a core or a vicinity of the core and a polished surface of a plurality of optical waveguides that are arranged in parallel in a longitudinal plane and that each have different propagation constants and whose side surfaces are polished to cores corresponding one to one therewith or vicinities of the cores; and
aligning the polished surface of the coated optical fiber and the polished surface of the plurality of optical waveguides so that desired branching ratio is obtained from one end of the coated optical fiber to the end, distal to the end, of one optical waveguide of the plurality of optical waveguides by relatively moving the polished surface of the coated optical fiber and the polished surface of the plurality of optical waveguides.

2. The optical multiplexing and demultiplexing method according to claim 1, wherein
the plurality of optical waveguides each have different core diameters causing the different propagation constants.

3. The optical multiplexing and demultiplexing method according to claim 1, wherein
the plurality of optical waveguides each have different refractive indices of at least one of the cores or cladding regions thereon causing the different propagation constants.

4. An optical multiplexing and demultiplexing circuit, wherein
a polished surface of a coated optical fiber whose side surface is polished to a core or a vicinity of the core and a polished surface of one optical waveguide of a plurality of optical waveguides that are arranged in parallel in a longitudinal plane and that each have different propagation constants and whose side surfaces are polished to cores corresponding one to one therewith or vicinities of the cores are joined.

5. The optical multiplexing and demultiplexing circuit according to claim 4, wherein
the plurality of optical waveguides each have different core diameters causing the different propagation constants.

6. The optical multiplexing and demultiplexing circuit according to claim 4, wherein
the plurality of optical waveguides each have different refractive indices of at least one of the cores or cladding regions thereon causing the different propagation constants.

7. A manufacturing method for an optical multiplexing and demultiplexing circuit, the method comprising:
arranging, face to face, a polished surface of a coated optical fiber whose side surface is polished to a core or a vicinity of the core and a polished surface of a plurality of optical waveguides that are arranged in parallel in a longitudinal plane and that each have different propagation constants and whose side surfaces are polished to cores corresponding one to one therewith or vicinities of the cores; and
fixing the polished surface of the coated optical fiber and the polished surface of the plurality of optical waveguides so that desired branching ratio is obtained from one end of the coated optical fiber to the end, distal to the former end, of one optical waveguide of the plurality of optical waveguides by relatively moving the polished surface of the coated optical fiber and the polished surface of the plurality of optical waveguides.
